(19) United States
(12) Patent Application Publication
(10) Pub. No.: US 2012/0219828 A1
(43) Pub. Date: Aug. 30, 2012

(54) PRODUCTION METHOD OF BASE PLATE FOR DISK DRIVE, BASE PLATE FOR DISK DRIVE, AND DISK DRIVE THEREWITH

(75) Inventors: Eiichi KOBAYASHI, Kitasaku-gun (JP); Akihiko SUZUKI, Kitasaku-gun (JP); Osamu TAKAHASHI, Kitasaku-gun (JP)

(73) Assignee: MINEBEA CO., LTD., Kitasaku-gun (JP)

(21) Appl. No.: 13/402,249

(22) Filed: Feb. 22, 2012

(30) Foreign Application Priority Data
Feb. 25, 2011 (JP) 2011-040359

(51) Int. Cl. G11B 5/73; B22D 25/02

(52) U.S. Cl. 428/846.4; 164/76.1

(57) ABSTRACT

A production method of a base plate for a disk drive made by aluminum die casting which can reduce scattering of particles and minimizes particle contamination is provided. The production method of a base plate for a disk drive includes a forming step for forming a base member by aluminum die casting, a coating step for coating the base member with a resin film, a machining step for removing a part of the resin film and a surface layer of the base member in order to expose the aluminum surface, a pretreatment step for immersing the base member with the exposed aluminum surface in a pretreatment solution containing no fluoride, and a metal film forming step for coating the exposed aluminum surface with a metal film.

### BACKGROUND OF THE INVENTION

1. Field of the Invention

The present invention relates to a production method of a base plate for a disk drive, a base plate for a disk drive, and a disk drive provided with the base plate.

2. Description of Related Art

In general, a disk drive such as a hard disk drive, which may be used in an electronic device, includes a base plate as a main part, and the base plate is formed with a recess and an open portion. The recess accommodates a magnetic disk (a recording medium), a spindle motor, a head stack assembly including a magnetic head, and the like. The open portion is sealed by a top cover. The base plate has a back side, that is, a surface at the side opposite to the recess, to which a control circuit board is fixed. The control circuit board is mounted with control circuits for the spindle motor, the magnetic head, an actuator, and the like, and an interface circuit for the electronic device.

Usually, the base plate is made by aluminum die casting which allows mass production at low cost. The base plate made by aluminum die casting is entirely coated with a resin film by electrodeposition so as to protect the surface and to prevent corrosion and occurrence of microscopic material causing contamination (hereinafter called “particles”). For example, a technique is disclosed in Japanese Unexamined Patent Application Laid-open No. 2008-27540. In this technique, after a base plate is machined, the base plate is cleaned and coated with a resin film having, for example, a thickness of not more than 50 μm. The resin film can be formed by electrodeposition coating.

The film formed by the electrodeposition coating tends to have a large thickness. Therefore, finishing is performed by machining the portions in which a high dimensional accuracy is required, such as a motor mounting portion, a mounting portion for a pivot bearing of the head stack assembly, etc. In addition, screw holes for fixing the top cover and the like are also formed by machining after the electrodeposition coating. Thus, the machining is essential after the electrodeposition coating. Accordingly, a conventional base plate has been used in a condition in which aluminum surface is exposed at machined portions.

In the machined portions with exposed aluminum surface, minute particles of approximately 0.1 micrometer to several micrometers in size adhere on the surface. These particles cannot be completely removed even by cleaning and they partially remain on the machined surface. On the other hand, the gap between the magnetic head and the magnetic disk has been extremely reduced to not more than 10 nm due to a recent trend toward increasing capacity and reducing dimensions. Therefore, failure of disk drive due to the collision of the magnetic head with the remaining particles adhered to the surface of the magnetic disk has occurred and become a problem.

Another technique is disclosed in Japanese Unexamined Patent Application Laid-open No. 2010-225207. In this technique, a base plate has an outer circumference provided with a circumferential wall made of plastic, thereby reducing generation of particles. The circumferential wall made of plastic does not oxidize and thereby does not generate particles.

### SUMMARY OF THE INVENTION

However, in the technique disclosed in Japanese Unexamined Patent Application Laid-open No. 2010-225207, generation of the particles at the machined portions of the base plate is not prevented. In view of these circumstances, it is an object of the present invention to provide a base plate for a disk drive made by aluminum die casting, in which scattering of the particles can be reduced, and a production method therefor.

In order to solve the above problem, the inventors of the present invention considered coating the machined portions, at which the base material consisting of aluminum is exposed, with a metal film so as to prevent the scattering of the particles by also coating them. In this case, in order to form a thin film which does not affect finish accuracy of the machined portions, the inventors of the present invention have searched for a plating process capable to control the film thickness of a few micrometers to form a film thinner than that of the electrodeposition coating.

Usually, for example, in an electroless nickel plating treatment, a pretreatment (etching) is performed so as to remove contaminants and oxide films on the metal surface. In the case of an aluminum die-casting alloy, large amounts of Si are contained as impurity compared with a steel material. Therefore, after an alkaline degreasing and an oxide film removal with a high-alkali solution, the base plate made by aluminum die-casting alloy is immersed in a pretreatment solution containing nitric acid and a fluoride. The fluoride may be hydrofluoric acid (HF), ammonium bifluoride (NH₄F.HF), ammonium fluoride (NH₄F), or the like. This is because the aluminum die-casting alloy has a surface layer containing Si in high concentration. If an aluminum surface is etched with only the nitric acid, Si remains on the aluminum surface and increases the surface roughness of the finished surface. In contrast, by mixing the fluoride into the pretreatment solution, Si is removed from the aluminum surface, and good surface roughness is obtained. However, the fluoride such as ammonium fluoride deteriorates the resin film formed by the electrodeposition coating. During an in-process inspection, when a deteriorated electrodeposition coating film is strongly rubbed with a cotton swab dipped in a solvent, the cotton swab becomes colored, and a small portion of the film comes off. Thus, the film is considered to be defective. Therefore, in the conventional plating method, there is a problem that the pretreatment solution used in the pretreatment deteriorates the electrodeposition coating film. Accordingly, in general, the plating has not been performed on the base plate after the electrodeposition coating.

In view of these circumstances, the inventors of the present invention have focused on the fact that the surface exposing the aluminum base material is resulted from the machining. They found that a good surface roughness can be obtained even without using the fluoride such as ammonium fluoride in the pretreatment solution. This is because the surface layer containing high concentration of Si can be removed by the machining, and also because the surface roughness can be improved by the machining. That is, the aluminum surface exposed by machining contains low concentration of Si and has good surface roughness. Therefore, the roughness of the surface is not greatly increased and is maintained in a practical level even without using the fluoride in the pretreatment solution. As the fluoride is not used in the pretreatment solution, a metal film can be formed by plating without deterioration of the resin film formed by electrodeposition coating.

In the plating process, the resin film formed by the electrodeposition coating is not plated, and only the machined portions are selectively plated, whereby masking is not necessary.

Accordingly, by not using the fluoride such as ammonium fluoride in the pretreatment solution, the plating became possible to be performed on the machined portions, at which the aluminum surface is exposed, after the electrodeposition coating.

The present invention provides a production method of a base plate for a disk drive, which has been completed based on the above findings. The production method includes a forming step for forming a base member by aluminum die casting. The base member has a surface layer with high concentration of Si. The production method also includes a coating step for coating the base member with a resin film and a machining step for removing a part of the resin film and the surface layer for exposing the aluminum surface. The production method further includes a pretreatment step for immersing the base member with the exposed aluminum surface in a pretreatment solution containing no fluoride and includes a metal film forming step for coating the exposed aluminum surface with a metal film.

According to the production method of the present invention, the concentration of Si at the exposed aluminum surface of the base member can be reduced because the surface layer containing high concentration of Si is removed by the machining step. Accordingly, although a pretreatment solution containing a fluoride is not used in the pretreatment step, good surface roughness is obtained. In addition, by using a pretreatment solution with no fluoride, the resin film covering the base member is not deteriorated, and the exposed aluminum surface is coated with the metal film in the subsequent metal film forming step. Thus, in the portion in which the aluminum base material is exposed by machining, the metal film fixes the particles, thereby preventing scattering of the particles from this portion. Therefore, scattering of the particles to the entire base plate is prevented.

In the production method of a base plate for the disk drive according to the present invention, the metal film is preferably formed by plating. In particular, the plating is preferably performed by electroless plating. More preferably, the electroless plating is performed by electroless nickel plating. By forming the metal film by the plating, specifically, by the electroless plating, thickness of the metal film is controlled to few micrometers, and effects of the metal film on the dimensional accuracy of the exposed aluminum surface are reduced. The electroless nickel plating is preferably used because it has already been widely used in other parts of a hard disk drive and is low in cost compared with other electroless platings.

Moreover, the present invention provides a base plate for a disk drive, and the base plate includes a base member, a resin film coating the base member, and a metal film. The base member is made by aluminum die casting. The metal film coats a part of the base member, at which the resin film and a surface layer of aluminum are removed by machining and the machined aluminum surface is exposed. According to the base plate of the present invention, the metal film coats the exposed aluminum surface, thereby fixing the particles generated by the machining. Accordingly, scattering of the particles to the entire base plate is prevented.

Furthermore, the present invention provides a disk drive provided with the base plate having the above structure. According to the present invention, the disk drive has the base plate in which the scattering of the particles is prevented, whereby collision of the particles with the magnetic head caused by the particles adhered to the surface of magnetic disk is prevented. Accordingly, failure of the disk drive is prevented.

According to the present invention, scattering of the particles is reduced in the base plate for the disk drive. Therefore, the disk drive can be prevented from breaking down due to problems caused by a collision between the particles adhering to a surface of the magnetic disk and the magnetic head. The disk drive of the present invention can be a hard disk drive.

### BRIEF DESCRIPTION OF THE DRAWINGS

FIGS. 1A and 1B are schematic views showing a base plate for a disk drive of the present invention.

FIG. 2 is a graph showing amounts of particles in a conventional base plate and in a base plate according to the present invention.

### PREFERRED EMBODIMENTS OF THE INVENTION

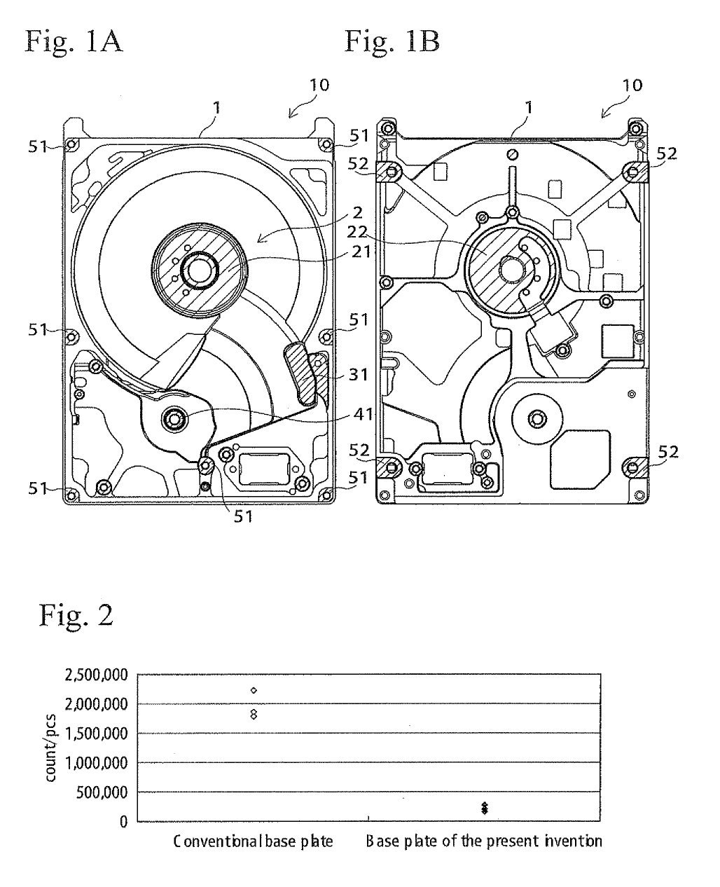

The present invention will be described in detail with reference to the figures hereinafter. FIGS. 1A and 1B show an example of a base plate for a disk drive of the present invention. FIG. 1A shows a front surface of the base plate, and FIG. 1B shows a back surface of the base plate. The base plate 10 is provided with a base member 1 as a main part. In the embodiment, the base member 1 is formed by aluminum die casting.

The base member 1 has a front surface on which a shallow recess 2 with a cylindrical shape is formed, and the recess 2 accommodates a magnetic disk and a spindle motor part (these are not shown in FIGS. 1A and 1B). The recess 2 is formed with a motor mounting surface 21 for the spindle motor part. The front surface of the base member 1 is provided with a ramp mounting surface 31 for a ramp (not shown in FIGS. 1A and 1B) which is used for placing a magnetic head. In addition, the front surface of the base member 1 is provided with a pivot bearing mounting surface 41 for mounting the head stack assembly including a pivot bearing unit, a swing arm and the magnetic head. The front surface of the base member 1 is also provided with screw holes and seating surfaces 51 for fixing a top cover (not shown in FIGS. 1A and 1B) so as to seal the base plate. The base member 1 has a back surface provided with a motor mounting surface 22 and screw holes and seating surfaces 52 for fixing a control circuit board (not shown in FIGS. 1A and 1B).

Next, a production method for the base plate 10 having the above structure will be described. First, the base member 1 as shown in FIGS. 1A and 1B is formed by aluminum die casting or the like (forming step). Then, the base member 1 is coated with a resin film by electrodeposition (coating step). The coating may be performed by another method besides the electrodeposition coating, such as dipping coating or spray coating.

In the case of the electrodeposition coating, the formed resin film has a large thickness. Therefore, finishing machining is performed on portions where high dimensional accuracy is required. In the present case, these portions are, for example, the motor mounting surfaces 21 and 22, the ramp mounting surface 31, the pivot bearing mounting surface 41, and the like. The screw holes and the seating surfaces 51 and 52, which are used for fixing the top cover or the control circuit board, are formed by machining after the electrodeposition coating. Therefore, the base member 1 is subjected to machining after the electrodeposition coating (machining step). The machining is performed so as to obtain necessary dimensional accuracy and to remove the surface layer of the aluminum base material, which contains high concentration of Si. In the machined portions, the resin film and the surface layer of the aluminum base material, which contains high concentration of Si, are removed, and simultaneously the surface roughness is improved. The machining is desirably performed so as to remove the surface layer of not less than 100 μm in depth from the surface of the aluminum base material.

After the machining step, the base member 1 is cleaned, whereby machining swarfs and oil are removed. Then, the oxide film on the exposed aluminum surfaces of the machined portions is removed with a high-alkali solution. Moreover, the base member 1 is immersed in a pretreatment solution containing no fluoride, whereby the aluminum surfaces of the machined portions are etched so as to remove contaminants, oxide films, and impurities thereon (pretreatment step). A nitric acid solution can be used as the pretreatment solution containing no fluoride. Next, a zinc substitution treatment or the like are performed before plating treatment. The zinc substitution treatment is commonly performed in an electroless nickel plating on aluminum. The zinc substitution treatment is performed for forming a zinc film on the active aluminum surface so as to prevent reoxidation of the aluminum surface and to facilitate nickel substitution in the electroless plating solution, thereby forming a metal film with high adhesiveness on the aluminum surface. Then, the aluminum surfaces of the machined portions are coated with a metal film by plating (metal film forming step). In this case, as described above, since the aluminum surface exposed by machining contains low concentration of Si, the surface roughness is not greatly deteriorated and is maintained to a practical level even with no use of a fluoride in the pretreatment solution. In the plating, the resin film formed by the electrodeposition coating is not plated, and only the machined portions are selectively plated, whereby masking is not necessary.

The electroless nickel plating in the present invention includes the electroless plating for forming a substantial nickel film or a metal film mainly containing nickel and also includes the electroless plating using nickel alloy. The elements which can be included besides nickel (Ni) are phosphorus (P), boron (B), cobalt (Co), iron (Fe), tungsten (W), copper (Cu), etc., for example. As electroless plating with a combination of nickel and other elements, Ni—P plating, Ni—B plating, Ni—P—B plating, Ni—Co alloy plating, Ni—Co—P alloy plating, Ni—Fe—P alloy plating, Ni—W—P alloy plating, Ni—Co—W—P alloy plating, Ni—Cu—P alloy plating, or the like, may be used. The electroless nickel plating uses a reducing agent which may be hypophosphite, sodium boron hydride, hydrazine, or the like. In addition, the metal film may be formed by electroless plating using another metal besides nickel. For example, electroless copper plating, etc., may be used. Moreover, the metal film coating the machined portions may be formed by another method besides the electroless plating as long as the metal film is formed to have a thickness of few micrometers for not affecting the finish accuracy. For example, spattering, vacuum deposition, etc., may be used. Nevertheless, the electroless plating is preferable in view of easiness of mass production and production cost.

The base plate 10 according to the present invention is produced by the production method including the above steps. According to the production method, the machined portions can be coated with the metal film without deteriorating the resin film covering the base member because the pretreatment solution containing no fluoride is used in the pretreatment step. The metal film fixes particles which are generated in the machining step, thereby preventing scattering of the particles from the machined portions. Accordingly, scattering of the particles to the entire base plate is prevented.

### EXAMPLES

The present invention will be more specifically described by using practical examples hereinafter. First, the base member 1 as shown in FIGS. 1A and 1B was formed by aluminum die casting, and the entire surface of the base member 1 was coated with epoxy resin by cation electrodeposition coating. In the cation electrodeposition coating, the base member 1 was immersed in an epoxy resin solution and was coated with an epoxy resin film of approximately 20 μm in thickness. Then, portions of the base member 1, which are required to have high dimensional accuracy as a base plate, were subjected to machining. Specifically, the machining was performed on the portions indicated by hatching lines in FIGS. 1A and 1B, such as the motor mounting surfaces 21 and 22, the ramp mounting surface 31, the pivot bearing mounting surface 41, and the screw holes and the seating surfaces 51 and 52. In the machined portions, the aluminum surface of the base member 1 was exposed, and the surface layer of aluminum was thinly cut off and was smoothly finished. The machining was performed with a cutting depth of 300 μm from the surface of the base member.

Next, the base member 1 was washed so as to remove machining swarfs. Then, the base member 1 was immersed in a solution of 30 to 40% of nitric acid at room temperature (20 to 30° C.) for 10 to 20 seconds, whereby the pretreatment (etching) was performed. After the zinc substitute treatment was performed, the base member 1 was subjected to the electroless nickel plating. In this case, even when the epoxy resin film coating the base member 1 was strongly rubbed with a cotton swab dipped in an acetone solution, the cotton swab did not become colored, indicating that the epoxy resin film not deteriorated by the pretreatment solution. That is, since the pretreatment solution containing no fluoride was used, nickel plating was formed without deteriorating the epoxy resin film formed by the electrodeposition coating. The nickel plating was performed on only the machined portions and had a thickness of 4 μm.

Similarly, three samples of the base plate were prepared. In these samples, the amount of particles on the base plate was measured by liquid particle count method which is a generally used method of counting particles for evaluating the cleanliness of hard disk drive components. First, each of the samples was immersed in ultrapure water in a container, and each of the whole container was subjected to ultrasonic waves for a predetermined time. Then, the amount of particles in the ultrapure water in each container was measured by a liquid particle counter (LPC). The result is shown in Table 1 and FIG. 2. For comparison, three samples of conventional base plate were prepared as in the case of the base plate of the present invention, except that the electroless nickel plating was not performed. In these samples, the amount of the particles was also measured in the same manner as in the case of the base plate of the present invention. This result is also shown in Table 1 and FIG. 2.

TABLE 1

| | Sample number | | | |
|---|---|---|---|---|
| | 1 | 2 | 3 | Average |
| Conventional base plate | 2,226,408 | 1,772,385 | 1,866,782 | 1,955,192 |
| Base plate of the | 166,500 | 188,105 | 272,792 | 209,132 |
| present invention | | | | |

The respective amount of particles relative to the three samples of the conventional base plate and three samples of the base plate according to the present invention is shown in Table 1 and FIG. 2. In addition, average values of the amounts of particles on the conventional base plates and on the base plates according to the present invention are shown in Table 1. As shown in Table 1 and FIG. 2, the amounts of particles on the base plates of the present invention were reduced to approximately 10% of those of the conventional base plates. This was because minute particles generated at the machined portions were fixed by coating the machined portions with the nickel plating. Accordingly, by coating the machined portions with a metal film, scattering of the particles was prevented, and the amount of particles on the base plate was extremely reduced.

The present invention can be used for a base plate for a hard disk drive.

What is claimed is:

1. A production method of a base plate for a disk drive, comprising:
a forming step for forming a base member by aluminum die casting;
a coating step for coating the base member with a resin film;
a machining step for removing a part of the resin film and a surface layer of the base member for exposing the aluminum surface;
a pretreatment step for immersing the base member with the exposed aluminum surface in a pretreatment solution containing no fluoride; and
a metal film forming step for coating the exposed aluminum surface with a metal film.

2. The production method of the base plate for the disk drive according to claim 1, wherein the metal film is formed by plating.

3. The production method of the base plate for the disk drive according to claim 2, wherein the plating is performed by electroless plating.

4. The production method of the base plate for the disk drive according to claim 3, wherein the electroless plating is performed by electroless nickel plating.

5. A base plate for a disk drive, comprising:
a base member made by aluminum die casting;
a resin film coating the base member; and
a metal film coating an aluminum surface portion which was exposed by removing the resin film and a surface layer of the base member by machining.

6. The base plate for the disk drive according to claim 5, wherein the metal film is formed by plating.

7. The base plate for the disk drive according to claim 6, wherein the plating is performed by electroless plating.

8. The base plate for the disk drive according to claim 7, wherein the electroless plating is performed by electroless nickel plating.

9. A disk drive provided with the base plate recited in claim 5.

10. A disk drive provided with the base plate recited in claim 6.

11. A disk drive provided with the base plate recited in claim 7.

12. A disk drive provided with the base plate recited in claim 8.
